(19) United States
(12) Patent Application Publication
(10) Pub. No.: US 2024/0308576 A1
(43) Pub. Date: Sep. 19, 2024

(54) METHOD TO CONTROL A STEERING SYSTEM OF A MOTOR VEHICLE WITH AN INCREASE IN SUPPLY VOLTAGE TO AN ACTUATOR MOTOR AFTER UNILATERAL FAILURE OF A REDUNDANT SYSTEM OR IN CASE OF EXTREME LOADS OR SHORT-TERM PERFORMANCE REQUIREMENTS

(71) Applicants: Thyssenkrupp Presta AG, Eschen (LI); Honda Motor Co., Ltd., Tokyo (JP)

(72) Inventors: Péter KAKAS, Budapest (HU); Imre SZEPESSY, Mauren (LI); Munetsugu HANJI, Wako-shi (JP); Yosuke OJIMA, Wako-shi (JP)

(21) Appl. No.: 18/675,507

(22) Filed: May 28, 2024

Related U.S. Application Data
(63) Continuation of application No. PCT/EP2021/083484, filed on Nov. 30, 2021.

(51) Int. Cl. B62D 5/04; B60L 1/00

(52) U.S. Cl. CPC B62D 5/0484; B60L 1/00

(57) ABSTRACT

A method to control a steering system of a road vehicle, the steering system including an actuator with at least two redundant power packs, the method including detecting a failure and/or degradation in or of the at least two redundant power packs of the actuator and/or switching off a malfunctioning one of the at least two redundant power packs, or detecting extreme loads or short-term performance requirements; and increasing a supply voltage for at least one functioning power pack of the actuator to a value higher than a supply voltage under normal conditions to provide a higher power output of the actuator than power output under normal conditions.

### CROSS REFERENCE TO RELATED APPLICATIONS

This application claims the benefit of priority to PCT Application No. PCT/EP2021/083484 filed on Nov. 30, 2021, the entire contents of which are hereby incorporated herein by reference.

### BACKGROUND OF THE INVENTION

### 1. Field of the Invention

The present invention relates to methods to control steering systems of motor vehicles and steering systems configured to carry out the methods.

### 2. Description of the Related Art

In motor vehicles, it is known to implement fail-functional architectures of steering systems. These include at least two powerpacks which include separate and independent controllers and motors. In a case of unilateral failure of the redundant system or extreme loads or short-term performance requirements, in electric power assisted steering systems (EPAS) with autonomous driving modes or in steer-by-wire steering systems, the power available may not be sufficient for steering functionality in all driving situations. Therefore, it can be desirable to increase performance of the steering system at least temporarily.

### SUMMARY OF THE INVENTION

Example embodiments of the present invention provide methods to control steering systems of motor vehicles, each of which enables a driver to steer the motor vehicle with full steering functionality as provided under normal conditions, at all times even after failure of an actuator.

A method to control a steering system of a road vehicle is provided, the steering system including an actuator with at least two redundant power packs, the method including detecting a failure and/or a degradation in or of one of the at least two redundant power packs of the actuator and/or switching off a malfunctioning one of the at least two redundant power packs, or detecting extreme loads or short-term performance requirements, and increasing a supply voltage for at least a functioning one of the at least two redundant power packs of the actuator to a value higher than a supply voltage under normal conditions to provide a higher power output of the actuator than a power under normal conditions.

The method makes it possible to partially compensate for a failure or degradation of one power pack and to also, in the case of extreme loads or short-term performance requirements, to provide an increase in power compared to normal conditions to provide full steering functionality. Preferably, the actuator is an actuator of a steer-by-wire steering system or an actuator of an electric power assisted steering system, which provides an assistance torque. In steer-by-wire systems, the actuator can be a road wheel actuator. In that case, it is preferred that the supply voltage is increased based on a gap between a target rack position and an actual rack position of the road wheel actuator. The supply voltage is increased at least temporarily. Preferably, until the gap between a target rack position and an actual rack position of the road wheel actuator becomes small, namely, it is less than a defined threshold. However, the actuator can also be the feedback actuator. In that case, it is preferred that the supply voltage increases based on the gap between a target feedback torque and an actual feedback torque of the feedback actuator. The supply voltage is increased at least temporarily, preferably until the gap between a target feedback torque and an actual feedback torque of the feedback actuator becomes small, i.e., is less than a defined threshold.

If the road vehicle is an electric vehicle, it is preferred that that a voltage converter is used to increase the supply voltage. If the road vehicle has an internal combustion engine, it is preferred that the increase in the supply voltage is generator controlled.

Further, according to another example embodiment of the present invention, a steering system for a road vehicle configured to perform the above described method is provided. The steering system can be a steer-by-wire system or an electric power assisted steering system.

The above and other elements, features, steps, characteristics and advantages of the present invention will become more apparent from the following detailed description of the example embodiments with reference to the attached drawings.

### BRIEF DESCRIPTION OF THE DRAWINGS

Example embodiments of the present invention will be described with reference to the drawings.

FIG. 1 is a schematic illustration of a steer-by-wire steering system of a motor vehicle.

FIG. 2 is a block diagram of a method to handle failure or degradation in a road wheel actuator of the steer-by-wire steering system.

### DETAILED DESCRIPTION OF THE EXAMPLE EMBODIMENTS

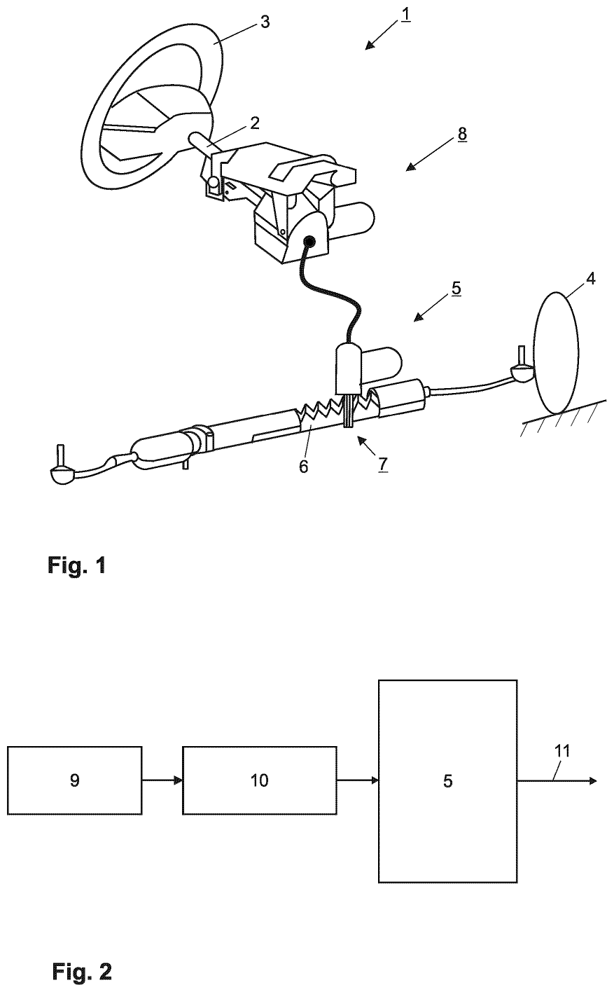

FIG. 1 is a schematic drawing of a steer-by-wire steering system 1 with a steering shaft 2 connected to a steering wheel 3. There is no mechanical connection between the steering wheel 3 and the road wheels 4. A road wheel actuator 5 operates a gear rack 6 via a rack-and-pinion gear 7.

When a driver operates the steering wheel 3, the steering shaft 2 is rotated, which is detected by a shaft sensor, which is not shown in the drawings. A controller calculates an operation signal for the road wheel actuator 5 from the signal detected by the shaft sensor. By operating the gear rack 6 with the operation signal, the road wheels 4 are turned. At the same time, forces introduced in the gear rack 6 from the road wheels 4 are recognized by another sensor not shown in the drawings, and a feedback signal is calculated, which is applied to the steering shaft 2 by a steering wheel actuator 8, also called a feedback actuator, so that the operator can recognize the feedback in the steering wheel 3.

The road wheel actuator 5 has a redundant power pack system with at least two redundant power packs, preferably two redundant power packs (not shown).

FIG. 2 is schematically a control method of the steer-by-wire steering system 1.

If a failure of one of the actuators 5,8 is detected 9, which can be a failure on one side of the redundant system or any degradation, the respective power pack is switched off and the performance of the road wheel actuator is reduced to the remaining functional powerpack.

The power of one powerpack under normal conditions is however not sufficient for steering functionality in all driving situations. Therefore, after detection of failure, the supply voltage of the at least one remaining powerpack is increased to increase the power to allow improved steering functionality.

Another situation can be that degradation in one of the actuators 5,8 takes place, which can be a degradation on one or more sides of the redundant system, which may reduce the remaining power. In case the degradation leads to a reduction in power, the remaining power might not be sufficient for steering functionality in all driving situations. Therefore, after detection of degradation, the supply voltage of the at least one degraded and/or the at least one fully functional powerpack is increased to increase the power to allow improved steering functionality.

In a third situation, the actuator 5,8 may be subjected to extreme loads or short-term performance requirements. To meet the requirements, the supply voltage of at least one powerpack is increased to increase the power to allow improved steering functionality.

In general, the actuator can be a road wheel actuator. In that case, it is preferred that the supply voltage is increased based on a gap between a target rack position and an actual rack position of the road wheel actuator. The supply voltage is increased at least temporarily, preferably, until the gap between a target rack position and an actual rack position of the road wheel actuator becomes small, i.e., is less than a defined threshold. However, the actuator can also be the feedback actuator. In that case, it is preferred that the supply voltage is increased based on the gap between a target feedback torque and an actual feedback torque of the feedback actuator. The supply voltage is increased at least temporarily, preferably until a gap between a target feedback torque and an actual feedback torque of the feedback actuator becomes small, i.e., is less than a defined threshold.

Generally, the increase is performed by a power supply provider 10. In the case of internal combustion engines, the voltage increase is generator controlled with a generator operating in a voltage control mode to measure a voltage, compare the measurement to a reference, and increase/decrease a reactive power flow out of the generating equipment. In the case of electric vehicles, a voltage converter is used to increase the supply voltage. The power supply provider 10 provides the increased supply voltage to the respective actuator 5, 8, which accordingly has an increased output power 11.

In another example embodiment of the present invention, the steering system is an electric power assisted steering system with an actuator. The actuator is used to assist a driver in applying torque to the steering mechanism, by applying an assistance torque of the same sense, to make it easier to turn the steering wheel. Thus, operation of the actuator may assist in rotating the steering column shaft, or moving a portion of the steering rack mechanism. Of course, the actuator may be connected to any part of any typical steering mechanism as long as it can provide an assistance torque to aid the driver in turning the steering wheel. In an analogy to the above description, the actuator is designed to be redundant with at least two power packs. In the case of failure or degradation of one side of the redundant system, or in the case of extreme loads or short-term performance requirements, the method described above also applies.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A method to control a steering system of a road vehicle, the steering system including an actuator with at least two redundant power packs, the method comprising:
a) detecting a failure and/or a degradation in or of one of the at least two redundant power packs of the actuator and/or switching off a malfunctioning one of the at least two redundant power packs; or
detecting extreme loads or short-term performance requirements; and
b) increasing a supply voltage for at least a functioning one of the at least two redundant power packs of the actuator to a value higher than a supply voltage under normal conditions to provide a higher power output of the actuator than a power output under normal conditions.

2. The method according to claim 1, wherein the actuator is a road wheel actuator or a feedback actuator of a steer-by-wire steering system or an actuator of an electric power assisted steering system, which provides an assistance torque.

3. The method according to claim 1, wherein the road vehicle is an electric vehicle, and in step b), a voltage converter is used to increase the supply voltage.

4. The method according to claim 1, wherein the road vehicle includes an internal combustion engine, and in step b), the increase in the supply voltage is generator controlled.

5. A steering system for a road vehicle configured to perform the method according to claim 1.
